(19) United States
(12) Patent Application Publication
(10) Pub. No.: US 2004/0019704 A1
(43) Pub. Date: Jan. 29, 2004

(54) Multiple processor integrated circuit having configurable packet-based interfaces

(76) Inventors: Barton Sano, Fremont, CA (US); Laurent Moll, Saratoga, CA (US); Manu Gulati, Santa Clara, CA (US); James Keller, Redwood City, CA (US)

Correspondence Address: GARLICK HARRISON & MARKISON LLP, P.O. BOX 160727, AUSTIN, TX, 78716-0727, US

(21) Appl. No.: 10/356,390

(22) Filed: Jan. 31, 2003

Related U.S. Application Data
(60) Provisional application No. 60/380,740, filed on May 15, 2002.
(60) Provisional application No. 60/419,032, filed on Oct. 16, 2002.

(51) Int. Cl. G06F 15/00; G06F 15/76; G06F 15/16

(52) U.S. Cl. 709/252; 712/29; 709/250

(57) ABSTRACT

A multiple processor integrated circuit includes a plurality of processing units, cache memory, a memory controller, an internal bus, a packet manager, a node controller, configurable packet-based interfaces, and a switching module. The internal bus couples the plurality of processing units, the cache memory, the memory controller, the packet manager, and the node controller together. The switching module couples the configurable packet-based interfaces with the packet manager and node controller. Each of the packet-based interfaces may be configured to provide a tunnel function, a bridge function, and/or a tunnel-bridge hybrid function. In the tunnel-bridge hybrid mode, the packet-based interfaces enable the multiple processor integrated circuit to provide peer-to-peer communication with other multiple processor integrated circuits in a processing system that includes a plurality of multiple processor ICs.

The present application claims priority under 35 U.S.C. 119(e) to the following applications, each of which is incorporated herein for all purposes:

(1) provisional patent application entitled SYSTEM ON A CHIP FOR NETWORKING, having an application No. of 60/380,740, and a filing date of May 15, 2002; and

(2) provisional patent application having the same title as above, having an application No. of 60/419,032, and a filing date of Oct. 16, 2002.

### BACKGROUND OF THE INVENTION

1. Technical Field of the Invention

The present invention relates generally to data communications and more particularly to high-speed wired data communications.

2. Description of Related Art

As is known, communication technologies that link electronic devices are many and varied, servicing communications via both physical media and wirelessly. Some communication technologies interface a pair of devices, other communication technologies interface small groups of devices, and still other communication technologies interface large groups of devices.

Examples of communication technologies that couple small groups of devices include buses within digital computers, e.g., PCI (peripheral component interface) bus, ISA (industry standard architecture) bus, an USB (universal serial bus), SPI (system packet interface) among others. One relatively new communication technology for coupling relatively small groups of devices is the HyperTransport (HT) technology, previously known as the Lightning Data Transport (LDT) technology (HyperTransport I/O Link Specification “HT Standard”). The HT Standard sets forth definitions for a high-speed, low-latency protocol that can interface with today's buses like AGP, PCI, SPI, 1394, USB 2.0, and 1 Gbit Ethernet as well as next generation buses including AGP 8x, Infiniband, PCI-X, PCI 3.0, and 10 Gbit Ethernet. HT interconnects provide high-speed data links between coupled devices. Most HT enabled devices include at least a pair of HT ports so that HT enabled devices may be daisy-chained. In an HT chain or fabric, each coupled device may communicate with each other coupled device using appropriate addressing and control. Examples of devices that may be HT chained include packet data routers, server computers, data storage devices, and other computer peripheral devices, among others.

Of these devices that may be HT chained together, many require significant processing capability and significant memory capacity. Thus, these devices typically include multiple processors and have a large amount of memory. While a device or group of devices having a large amount of memory and significant processing resources may be capable of performing a large number of tasks, significant operational difficulties exist in coordinating the operation of multiple processors. While each processor may be capable of executing a large number operations in a given time period, the operation of the processors must be coordinated and memory must be managed to assure coherency of cached copies. In a typical multi-processor installation, each processor typically includes a Level 1 (L1) cache coupled to a group of processors via a processor bus. The processor bus is most likely contained upon a printed circuit board. A Level 2 (L2) cache and a memory controller (that also couples to memory) also typically couples to the processor bus. Thus, each of the processors has access to the shared L2 cache and the memory controller and can snoop the processor bus for its cache coherency purposes. This multi-processor installation (node) is generally accepted and functions well in many environments.

However, network switches and web servers often times require more processing and storage capacity than can be provided by a single small group of processors sharing a processor bus. Thus, in some installations, a plurality processor/memory groups (nodes) is sometimes contained in a single device. In these instances, the nodes may be rack mounted and may be coupled via a back plane of the rack. Unfortunately, while the sharing of memory by processors within a single node is a fairly straightforward task, the sharing of memory between nodes is a daunting task. Memory accesses between nodes are slow and severely degrade the performance of the installation. Many other shortcomings in the operation of multiple node systems also exist. These shortcomings relate to cache coherency operations, interrupt service operations, etc.

While HT links provide high-speed connectivity for the above-mentioned devices and in other applications, they are inherently inefficient in some ways. For example, in a “legal” HT chain, one HT enabled device serves as a host bridge while other HT enabled devices serve as dual link tunnels and a single HT enabled device sits at the end of the HT chain and serves as an end-of-chain device (also referred to as an HT “cave”). According to the HT Standard, all communications must flow through the host bridge, even if the communication is between two adjacent devices in the HT chain. Thus, if an end-of-chain HT device desires to communicate with an adjacent HT tunnel, its transmitted communications flow first upstream to the host bridge and then flow downstream from the host bridge to the adjacent destination device. Such communication routing, while allowing the HT chain to be well managed, reduces the overall throughput achievable by the HT chain, increases latency of operations, and reduces concurrency of transactions.

Applications, including the above-mentioned devices, that otherwise benefit from the speed advantages of the HT chain are hampered by the inherent delays and transaction routing limitations of current HT chain operations. Because all transactions are serviced by the host bridge and the host a limited number of transactions it can process at a given time, transaction latency is a significant issue for devices on the HT chain, particularly so for those devices residing at the far end of the HT chain, i.e., at or near the end-of-chain device. Further, because all communications serviced by the HT chain, both upstream and downstream, must share the bandwidth provided by the HT chain, the HT chain may have insufficient total capacity to simultaneously service all required transactions at their required bandwidth(s). Moreover, a limited number of transactions may be addressed at any time by any one device such as the host, e.g., 32 transactions (2**5). The host bridge is therefore limited in the number of transactions that it may have outstanding at any time and the host bridge may be unable to service all required transactions satisfactorily. Each of these operational limitations affects the ability of an HT chain to service the communications requirements of coupled devices.

Further, even if an HT enabled device were incorporated into a system (e.g., an HT enabled server, router, etc. were incorporated into an circuit-switched system or packet-switched system), it would be required to interface with a legacy device that uses an older communication protocol. For example, if a line card were developed with HT ports, the line card would need to communicate with legacy line cards that include SPI ports.

Therefore, a need exists for methods and/or apparatuses for interfacing devices using one or more communication protocols in one or more configurations while overcoming the bandwidth limitations, latency limitations, limited concurrency, and other limitations associated with the use of a high-speed HT chain.

### BRIEF SUMMARY OF THE INVENTION

The multiple processor integrated circuit (IC) of the present invention substantially meets these needs and others. The multiple processor integrated circuit includes a plurality of processing units, cache memory, a memory controller, an internal bus, a packet manager, a node controller, configurable packet-based interfaces, and a switching module. The internal bus couples the plurality of processing units, the cache memory, the memory controller, the packet manager, and the node controller together. The switching module couples the configurable packet-based interfaces with the packet manager and node controller. Each of the packet-based interfaces may be configured to provide a tunnel function, a bridge function, and/or a tunnel-bridge hybrid function. In the tunnel-bridge hybrid mode, the packet-based interfaces enable the multiple processor integrated circuit to provide peer-to-peer communication with other multiple processor integrated circuits in a processing system that includes a plurality of multiple processor ICs. As such, the multiple processor integrated circuit in accordance with the present invention supports multiple configurations while overcoming bandwidth limitations, latency limitations and other limitations associated with high speed HyperTransport chains.

The packet-based interface, which may be used in a multiple processor integrated circuit, includes an input/output module, a media access control (MAC) module, and a tunnel-bridge hybrid module (which may be within the interface, within the packet manager and/or the node controller, or a stand-alone circuit). The input/output module is operably coupled to amplify received data packets from a physical link and to drive outbound data packets onto the physical link. The media access control module is operably coupled to format outbound data to produce the outbound data packets. The formatting may be done in accordance with a packet-based protocol (e.g., HyperTransport, system packet interface, et cetera). In addition, the media access control module recaptures inbound packets, in accordance with the packet-based protocol, from the amplified inbound data.

The tunnel-bridge hybrid module is operably coupled to interpret a packet of the inbound packets to determine a destination of the packet. When the destination of the packet is a local module associated with the packet-based interface (i.e., a component within the multiple processor integrated circuit), the hybrid module provides the packet to the local module via a switch. When the destination of the packet is not local to the packet-based interface, the hybrid module forwards the packet to the media access control module for transmission as an outbound packet. Such a packet-based interface, when used within a multiple processor integrated circuit, enables the multiple processor integrated circuit to interface with other devices utilizing one or more communication protocols and be configured in one or more configurations while overcoming bandwidth limitations, latency limitations, concurrency issues, and other limitations associated with high speed chains.

A processing system may be constructed using a plurality of multiple processor devices, which may be integrated circuits, wherein each of the multiple processor devices includes packet-based interfaces. One of the multiple processor devices has its packet-based interfaces configured to enable the multiple processor device to function as a host for the processing system. The remaining multiple processors of the processing system have their packet-based interfaces configured as bridges to allow the multiple processor devices to support peer-to-peer communications within the processing system. Such a system allows the interfacing of the devices using one or more communication protocols and be configured in a particular configuration to overcome bandwidth limitations, latency limitations and other limitations associated with high-speed chains.

Another embodiment of a processing system includes a plurality of multiple processor devices, which may be integrated circuits, where each of the multiple processor devices includes packet-based interfaces. In this embodiment, one of the multiple processor devices has its packet-based interfaces configured to enable the multiple processor device to function as a host for the processing system while the remaining multiple processor devices have their interfaces configured to enable the multiple processor devices to provide a tunnel-bridge hybrid function. In this configuration, the multiple processor devices support peer-to-peer communications within the processing system. Such a system allows for the interfacing of the devices using one or more communication protocols and be configured in a particular way to overcome bandwidth limitations, latency limitations and other limitations associated with high-speed chains.

### BRIEF DESCRIPTION OF THE SEVERAL VIEWS OF THE DRAWINGS

FIG. 1 is a schematic block diagram of a processing system in accordance with the present invention;

FIG. 2 is a schematic block diagram of an alternate processing system in accordance with the present invention;

FIG. 3 is a schematic block diagram of another processing system in accordance with the present invention;

FIG. 4 is a schematic block diagram of a multiple processor device in accordance with the present invention;

FIG. 5 is a graphical representation of transporting data between devices in accordance with the present invention; and

FIGS. 6 and 7 illustrate a logic diagram of a method for providing interfacing between multiple processor devices within a processing system in accordance with the present invention.

### DETAILED DESCRIPTION OF THE INVENTION

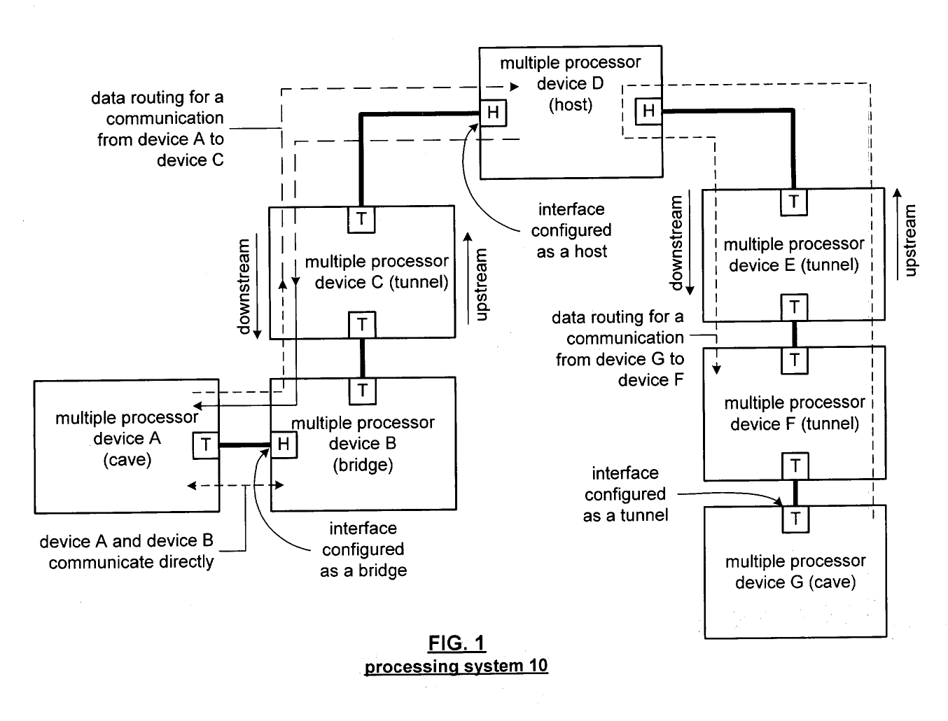

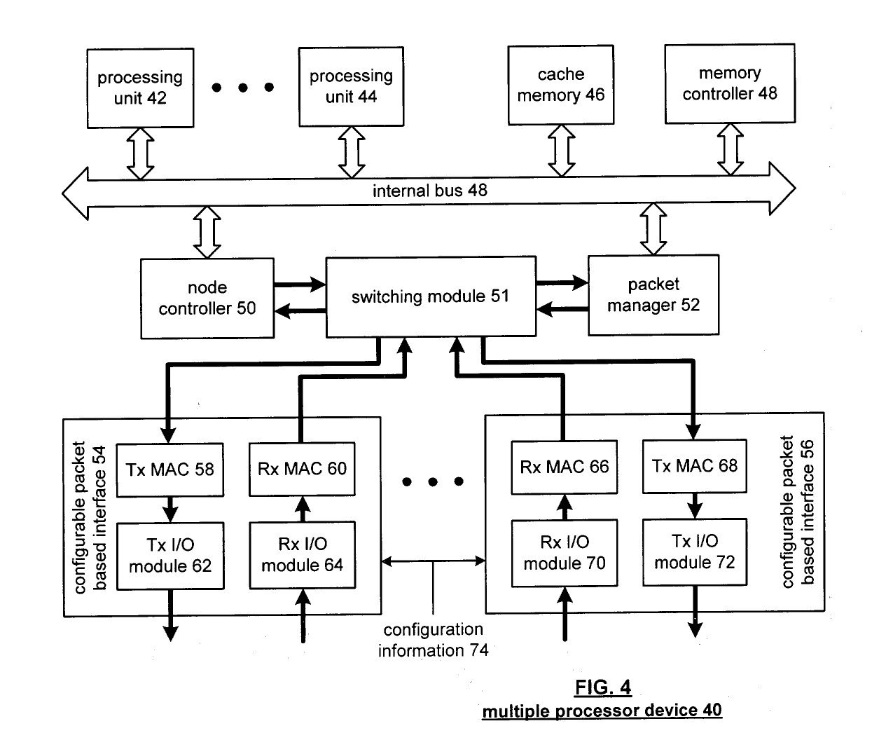

FIG. 1 is a schematic block diagram of a processing system 10 that includes a plurality of multiple processor devices A-G. Each of the multiple processor devices A-G include at least two interfaces, which, in this illustration, are labeled as T for tunnel functionality or H for host or bridge functionality. The details of the multiple processor devices A-G will be described in greater detail with reference to FIG. 4.

In this example of a processing system 10, multiple processor device D is functioning as a host to support two primary chains. The 1^{st} primary chain includes multiple processor device C, which is configured to provide a tunnel function, and multiple processor device B, which is configured to provide a bridge function. The other primary chain supported by device D includes multiple processor devices E and F, which are each configured to provide tunneling functionality, and multiple processor device G, which is configured to provide a cave function. The processing system 10 also includes a secondary chain that includes multiple processor devices A and B, where device A is configured to provide a cave function. Multiple processor device B functions as the host for the secondary chain. By convention, data from the devices (i.e., nodes) in a chain to the host device is referred to as upstream data and data from the host device to the node devices is referred to as downstream data.

In general, when a multiple processor device is providing a tunneling function, it passes, without interpretation, all packets received from downstream devices (i.e., the multiple processor devices that, in the chain, are further away from the host device) to the next upstream device (i.e., an adjacent multiple processor device that, in the chain, is closer to the host device). For example, multiple processor device E provides all upstream packets received from downstream multiple processor devices F and G to host device D without interpretation, even if the packets are addressing multiple processor device E. The host device D modifies the upstream packets to identify itself as the source of packets and sends the modified packets downstream along with any packets that it generated. As the multiple processor devices receive the downstream packets, they interpret the packet to identify the host device as the source and to identify a destination. If the multiple processor device is not the destination, it passes the downstream packets to the next downstream node. For example, packets received from the host device D that are directed to the multiple processor device E will be processed by the multiple processor device E, but device E will pass packets for devices F and G. The processing of packets by device E includes routing the packets to a particular processing unit within device E, routing to local memory, routing to external memory associated with device E, et cetera.

In this configuration, if multiple processor device G desires to send packets to multiple processor device F, the packets would traverse through devices E and F to host device D. Host device D modifies the packets identifying the multiple processor device D as the source of the packets and provides the modified packets to multiple processor device E, which would in turn forward them to multiple processor device F. A similar type of packet flow occurs for multiple processor device B communicating with multiple processor device C, for communications between devices G and E, and for communications between devices E and F.

For the secondary chain, devices A and B can communication directly, i.e., they support peer-to-peer communications therebetween. In this instance, the multiple processor device B has one of its interfaces (H) configured to provide a bridge function. Accordingly, the bridge functioning interface of device B interprets packets it receives from device A to determine the destination of the packet. If the destination is local to device B (i.e., meaning the destination of the packet is one of the modules within multiple processor device B or associated with multiple processor device B), the H interface processes the received packet. The processing includes forwarding the packet to the appropriate destination within, or associated with, device B.

If the packet is not destined for a module within device B, multiple processor device B modifies the packet to identify itself as the source of the packets. The modified packets are then forwarded to the host device D via device C, which is providing a tunneling function. For example, if device A desires to communicate with device C, device A provides packets to device B and device B modifies the packets to identify itself as the source of the packets. Device B then provides the modified packets to host device D via device C. Host device D then, in turn, modifies the packets to identify itself as the source of the packets and provides the again modified packets to device C, where the packets are subsequently processed. Conversely, if device C were to transmit packets to device A, the packets would first be sent to host D, modified by device D, and the modified packets would be provided back to device C. Device C, in accordance with the tunneling function, passes the packets to device B. Device B interprets the packets, identifies device A as the destination, and modifies the packets to identify device B as the source. Device B then provides the modified packets to device A for processing thereby.

In the processing system 10, device D, as the host, assigns a node ID (identification code) to each of the other multiple processor devices in the system. Multiple processor device D then maps the node ID to a unit ID for each device in the system, including its own node ID to its own unit ID. Accordingly, by including a bridging functionality in device B, in accordance with the present invention, the processing system 10 allows for interfacing between devices using one or more communication protocols and may be configured in one or more configurations while overcoming bandwidth limitations, latency limitations and other limitations associated with the use of high speed HyperTransport chains. Such communication protocols include, but are not limited to, a HyperTransport protocol, system packet interface (SPI) protocol and/or other types of packet-switched or circuit-switched protocols.

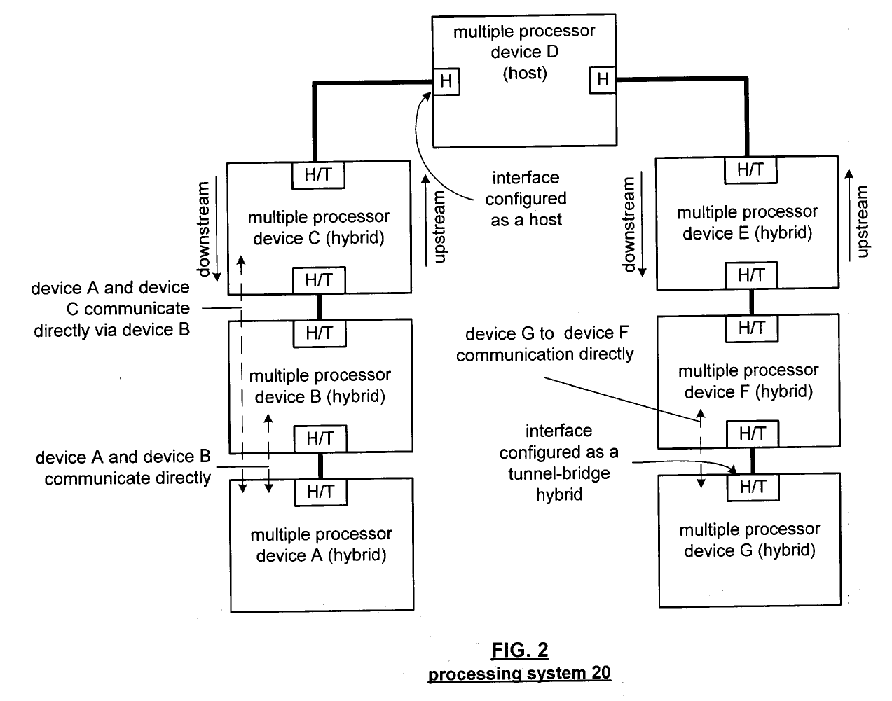

FIG. 2 is a schematic block diagram of an alternate processing system 20 that includes a plurality of multiple processor devices A-G. In this system 20, multiple processor device D is the host device while the remaining devices are configured to support a tunnel-bridge hybrid interfacing functionality. Each of multiple processor devices A-C and E-G have their interfaces configured to support the tunnel-bridge hybrid (H/T) mode. With the interfacing configured in this manner, peer-to-peer communications may occur between multiple processor devices in a chain. For example, multiple processor device A may communicate directly with multiple processor device B and may communicate with multiple processor device C, via device B, without routing packets through the host device D. For peer-to-peer communication between devices A and B, multiple processor device B interprets the packets received from multiple processor device A to determine whether the destination of the packet is local to multiple processor device B. With reference to FIG. 4, a destination associated with multiple processor device B may be any one of the plurality of processing units 42-44, cache memory 46 or system memory accessible through the memory controller 48. Returning back to the diagram of FIG. 2, if the packets received from device A are destined for a module within device B, device B processes the packets by forwarding them to the appropriate module within device B. If the packets are not destined for device B, device B forwards them, without modifying the source of the packets, to multiple processor device C. As such, for this example, the source of packets remains device A.

The packets received by multiple processor device C are interpreted to determine whether a module within multiple processor device C is the destination of the packets. If so, device C processes them by forwarding the packets to the appropriate module within, or associated with, device C. If the packets are not destined for a module within device C, device C forwards them to the multiple processor device D. Device D modifies the packets to identify itself as the source of the packets and provides the modified packets to the chain including devices E-G. Note that device C, having interpreted the packets, passes only packets that are destined for a device other than itself in the upstream direction. Since device D is the only upstream device for the primary chain that includes device C, device D knows, based on the destination address, that the packets are for a device in the other primary chain.

Devices E-G, in order, interpret the modified packets to determine whether it is a destination of the modified packets. If so, the device processes the packets. If not, the device routes the packets to the next device in chain. In addition, devices E-G support peer-to-peer communications in a similar manner as devices A-C. Accordingly, by configuring the interfaces of the devices to support a tunnel-bridge hybrid function, the source of the packets is not modified (except when the communications are between primary chains of the system), which enables the devices to use one or more communication protocols (e.g., HyperTransport, system packet interface, et cetera) in a peer-to-peer configuration that substantially overcomes the bandwidth limitations, latency limitations and other limitations associated with the use of a conventional high-speed HyperTransport chain.

In general, a device configured as a tunnel-bridge hybrid has knowledge about which direction to send requests. For example, for device C to communicate with device A, device C knows that device A is downstream and is coupled to device B. As such, device C sends packets to device B for forwarding to device A as opposed to a traditional tunnel function, where device C would have to send packets for device A to device D, where device D would provide them back downstream after redefining itself as the source of the packets. To facilitate the more direct communications, each device maintains the address ranges, in range registers, for each link (or at least one of its links) and enforces ordering rules regardless of the Unit ID across its interfaces.

To facilitate the tunnel-hybrid functionality, since each device receives a unique Node ID, request packets are generated with the device's unique Node ID in the a Unit ID field of the packet. For packets that are forwarded upstream (or downstream), the Unit ID field and the source ID field of the request packets are preserved. As such, when the target device receives a request packet, the target device may accept the packet based on the address.

When the target device generates a response packet in response to a request packet(s), it uses the unique Node ID of the requesting device rather than the Node ID of the responding device. In addition, the responding device also preserves the Source Tag of the requesting device such that the response packet includes the Node ID and Source Tag of the requesting device. This enables the response packets to be accepted based on the Node ID rather than based on a bridge bit or direction of travel of the packet.

For a device to be configured as a tunnel-bridge hybrid, it export, at configuration of the system 20, a type 1 header (i.e., a bridge header in accordance with the HT specification) in addition to, or in place of, a type 0 header (i.e., a tunnel header in accordance with the HT specification). In response to the type 1 header, the host device programs the address range registers of the devices A-C and E-G regarding one or more links coupled to the devices. Once configured, the device utilizes the addresses in its address range registers to identify the direction (i.e., upstream link or downstream link) to send request packets and/or response packets to a particular device as described above.

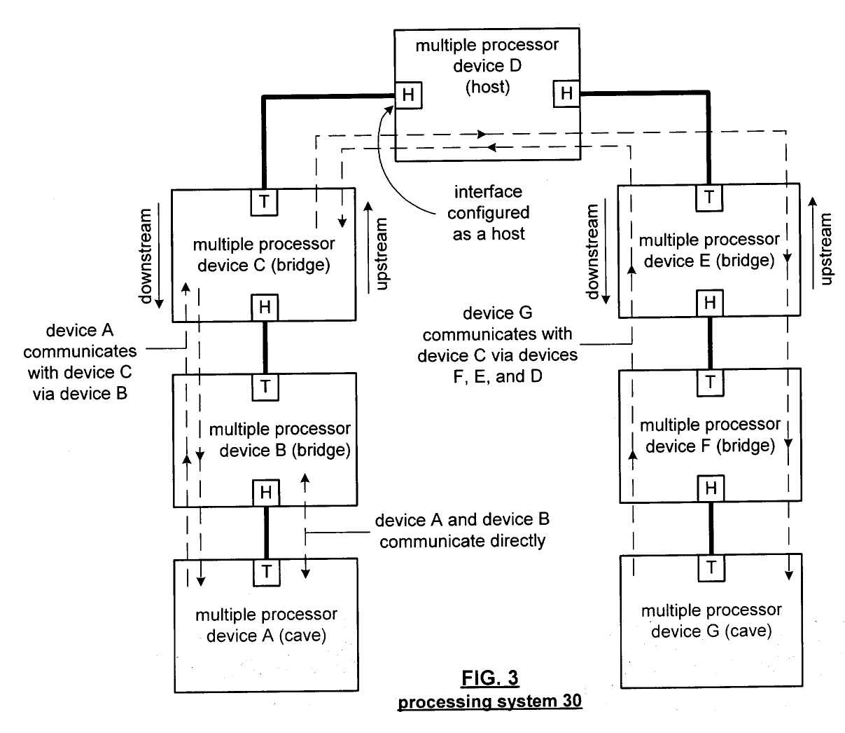

FIG. 3 is a schematic block diagram of processing system 30 that includes multiple processor devices A-G. In this embodiment, multiple processor device D is functioning as a host device for the system while the multiple processor devices B, C, E and F are configured to provide bridge functionality and devices A and G are configured to support a cave function. In this configuration, each of the devices may communicate directly (i.e., have peer-to-peer communication) with adjacent multiple processor devices via cascaded secondary chains. For example, device A may directly communicate with device B via a secondary chain therebetween, device B may communicate directly with device C via a secondary chain therebetween, device E may communicate directly with device F via a secondary chain therebetween, and device F may communicate directly with device G via a secondary chain therebetween. The primary chains in this example of a processing system exist between device D and device C and between device D and device E.

For communication between devices A and B, device B interprets packets received from device A to determine their destination. If device B is the destination, it processes it by providing it to the appropriate destination within, or associated with, device B. If a packet is not destined for device B, device B modifies the packet to identify itself as the source and forwards it to device C. Accordingly, if device A desires to communicate with device B, it does so directly since device B is providing a bridge function with respect to device A. However, for device A desires to communicate with device C, device B, as the host for the chain between devices A and B, modifies the packets to identify itself as the source of the packets. The modified packets are then routed to device C. To device C, the packets appear to be sourced from device B and not device A. For packets from device C to device A, device B modifies the packets to identify itself as the source of the packets and provides the modified packets to device A. In such a configuration, each device only knows that it is communicating with one device in the downstream direct and one device in the upstream direction. As such, peer-to-peer communication is supported directly between adjacent devices and is also supported indirectly (i.e., by modifying the packets to identify the host of the secondary chain as the source of the packets) between any devices in the system.

In any of the processing systems illustrated in FIGS. 1-3, the devices on one chain may communicate with devices on the other chain. An example of this is illustrated in FIG. 3 where device G may communicate with device C. As shown, packets from device G are propagated through devices D, E and F until they reach device C. Similarly, packets from device C are propagated through devices D, E and F until they reach device G. In the example of FIG. 3, the packets in the downstream direction and in the upstream direction are adjusted to modify the source of the packets. Accordingly, packets received from device G appear, to device C, to be originated by device D. Similarly, packets from device C appear, to device G, to be sourced by device F. As one of average skill in the art will appreciate, each device that is providing a host function or a bridge function maintains a table of communications for the chains it is the host to track the true source of the packets and the true destination of the packets.

FIG. 4 is a schematic block diagram of a multiple processor device 40 in accordance with the present invention. The multiple processor device 40 may be an integrated circuit or it may be constructed from discrete components. In either implementation, the multiple processor device 40 may be used as multiple processor device A-G in the processing systems illustrated in FIGS. 1-3.

The multiple processor device 40 includes a plurality of processing units 42-44, cache memory 46, memory controller 48, which interfaces with on and/or off-chip system memory, an internal bus 48, a node controller 50, a switching module 51, a packet manager 52, and a plurality of configurable packet based interfaces 54-56 (only two shown). The processing units 42-44, which may be two or more in numbers, may have a MIPS based architecture, to support floating point processing and branch prediction. In addition, each processing unit 42-44 may include a memory sub-system of an instruction cache and a data cache and may support separately, or in combination, one or more processing functions. With respect to the processing system of FIGS. 1-3, each processing unit 42-44 may be a destination within multiple processor device 40 and/or each processing function executed by the processing modules 42-44 may be a destination within the processor device 40.

The internal bus 48, which may be a 256 bit cache line wide split transaction cache coherent bus, couples the processing units 42-44, cache memory 46, memory controller 48, node controller 50 and packet manager 52 together. The cache memory 46 may function as an L2 cache for the processing units 42-44, node controller 50 and/or packet manager 52. With respect to the processing system of FIGS. 1-3, the cache memory 46 may be a destination within multiple processor device 40.

The memory controller 48 provides an interface to system memory, which, when the multiple processor device 40 is an integrated circuit, may be off-chip and/or on-chip. With respect to the processing system of FIGS. 1-3, the system memory may be a destination within the multiple processor device 40 and/or memory locations within the system memory may be individual destinations within the device 40. Accordingly, the system memory may include one or more destinations for the processing systems illustrated in FIGS. 1-3.

The node controller 50 functions as a bridge between the internal bus 48 and the configurable packet-based interfaces 54-56. Accordingly, accesses originated on either side of the node controller will be translated and sent on to the other. The node controller also supports the distributed shared memory model associated with the cache coherency non-uniform memory access (CC-NUMA) protocol.

The switching module 51 couples the plurality of configurable packet-based interfaces 54-56 to the node controller 50 and/or to the packet manager 52. The switching module 51 functions to direct data traffic, which may be in a generic format, between the node controller 50 and the configurable packet-based interfaces 54-56 and between the packet manager 52 and the configurable packet-based interfaces 54. The generic format may include 8 byte data words or 16 byte data words formatted in accordance with a proprietary protocol, in accordance with asynchronous transfer mode (ATM) cells, in accordance with internet protocol (IP) packets, in accordance with transmission control protocol/internet protocol (TCP/IP) packets, and/or in general, in accordance with any packet-switched protocol or circuit-switched protocol.

The packet manager 52 may be a direct memory access (DMA) engine that writes packets received from the switching module 51 into input queues of the system memory and reads packets from output queues of the system memory to the appropriate configurable packet-based interface 54-56. The packet manager 52 may include an input packet manager and an output packet manager each having its own DMA engine and associated cache memory. The cache memory may be arranged as first in first out (FIFO) buffers that respectively support the input queues and output queues.

The configurable packet-based interfaces 54-56 generally function to convert data from a high-speed communication protocol (e.g., HT, SPI, etc.) utilized between multiple processor devices 40 and the generic format of data within the multiple processor devices 40. Accordingly, the configurable packet-based interface 54 or 56 may convert received HT or SPI packets into the generic format packets or data words for processing within the multiple processor device 40. In addition, the configurable packet-based interfaces 54 and/or 56 may convert the generic formatted data received from the switching module 51 into HT packets or SPI packets. The particular conversion of packets to generic formatted data performed by the configurable packet-based interfaces 54 and 56 is based on configuration information 74, which, for example, indicates configuration for HT to generic format conversion or SPI to generic format conversion.

Each of the configurable packet-based interfaces 54-56 includes a transmit media access controller (Tx MAC) 58 or 68, a receiver (Rx) MAC 60 or 66, a transmitter input/output (I/O) module 62 or 72, and a receiver input/output (I/O) module 64 or 70. In general, the transmit MAC module 58 or 68 functions to convert outbound data of a plurality of virtual channels in the generic format to a stream of data in the specific high-speed communication protocol (e.g., HT, SPI, etc.) format. The transmit I/O module 62 or 72 generally functions to drive the high-speed formatted stream of data onto the physical link coupling the present multiple processor device 40 to another multiple processor device. The transmit I/O module 62 or 72 is further described, and incorporated herein by reference, in co-pending patent application entitled MULTI-FUNCTION INTERFACE AND APPLICATIONS THEREOF, having an attorney docket number of BP 2389, and having the same filing date and priority date as the present application. The receive MAC module 60 or 66 generally functions to convert the received stream of data from the specific high-speed communication protocol (e.g., HT, SPI, etc.) format into data from a plurality of virtual channels having the generic format. The receive I/O module 64 or 70 generally functions to amplify and time align the high-speed formatted steam of data received via the physical link coupling the present multiple processor device 40 to another multiple processor device. The receive I/O module 64 or 70 is further described, and incorporated herein by reference, in co-pending patent application entitled RECEIVER MULTI-PROTOCOL INTERFACE AND APPLICATIONS THEREOF, having an attorney docket number of BP 2389.1, and having the same filing date and priority date as the present application.

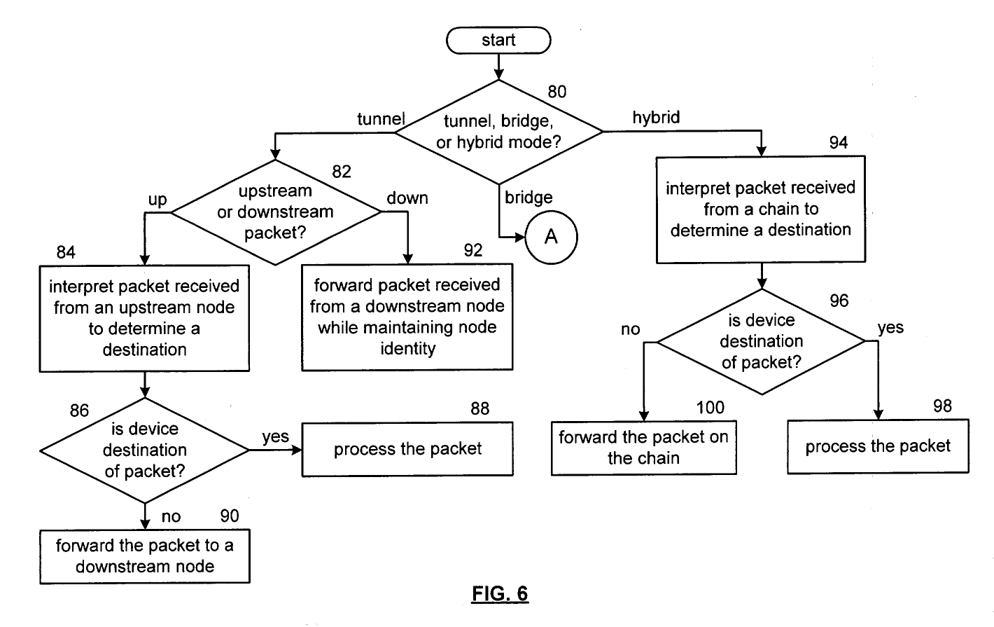

The transmit and/or receive MACs 58, 60, 66 and/or 68 may include, individually or in combination, a processing module and associated memory to perform its correspond functions The processing module may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory may be a single memory device or a plurality of memory devices. Such a memory device may be a read-only memory, random access memory, volatile memory, non-volatile memory, static memory, dynamic memory, flash memory, and/or any device that stores digital information. Note that when the processing module implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry. The memory stores, and the processing module executes, operational instructions corresponding to the functionality performed by the transmitter MAC 58 or 68 as disclosed, and incorporated herein by reference, in co-pending patent application entitled TRANSMITTING DATA FROM A PLURALITY OF VIRTUAL CHANNELS VIA A MULTIPLE PROCESSOR DEVICE, having an attorney docket number of BP 2184.1 and having the same filing date and priority date as the present patent application and corresponding to the functionality performed by the receiver MAC module 60 or 66 as further described in FIGS. 6-10.

In operation, the configurable packet-based interfaces 54-56 provide the means for communicating with other multiple processor devices 40 in a processing system such as the ones illustrated in FIG. 1, 2 or 3. The communication between multiple processor devices 40 via the configurable packet-based interfaces 54 and 56 is formatted in accordance with a particular high-speed communication protocol (e.g., HyperTransport (HT) or system packet interface (SPI)). The configurable packet-based interfaces 54-56 may be configured to support, at a given time, one or more of the particular high-speed communication protocols. In addition, the configurable packet-based interfaces 54-56 may be configured to support the multiple processor device 40 in providing a tunnel function, a bridge function, or a tunnel-bridge hybrid function.

When the multiple processor device 40 is configured to function as a tunnel-hybrid node, the configurable packet-based interface 54 or 56 receives the high-speed communication protocol formatted stream of data and separates, via the MAC module 60 or 68, the stream of incoming data into generic formatted data associated with one or more of a plurality a particular virtual channels. The particular virtual channel may be associated with a local module of the multiple processor device 40 (e.g., one or more of the processing units 42-44, the cache memory 46 and/or memory controller 48) and, accordingly, corresponds to a destination of the multiple processor device 40 or the particular virtual channel may be for forwarding packets to the another multiple processor device.

The interface 54 or 56 provides the generically formatted data words, which may comprise a packet, or portion thereof, to the switching module 51, which routes the generically formatted data words to the packet manager 52 and/or to node controller 50. The node controller 50, the packet manager 52 and/or one or more processing units 42-44 interprets the generically formatted data words to determine a destination therefor. If the destination is local to multiple processor device 40 (i.e., the data is for one of processing units 42-44, cache memory 46 or memory controller 48), the node controller 50 and/or packet manager 52 provides the data, in a packet format, to the appropriate destination. If the data is not addressing a local destination, the packet manager 52, node controller 50 and/or processing unit 42-44 causes the switching module 51 to provide the packet to one of the other configurable packet-based interfaces 54 or 56 for forwarding to another multiple processor device in the processing system. For example, if the data were received via configuration packet-based interface 54, the switching module 51 would provide the outgoing data to configurable packet-based interface 56. In addition, the switching module 51 provides outgoing packets generated by the local modules of processing module device 40 to one or more of the configurable packet-based interfaces 54-56.

The configurable packet-based interface 54 or 56 receives the generic formatted data via the transmitter MAC module 58 or 68. The transmitter MAC module 58, or 68 converts the generic formatted data from a plurality of virtual channels into a single stream of data. The transmitter input/output module 62 or 72 drives the stream of data on to the physical link coupling the present multiple processor device to another.

When the multiple processor device 40 is configured to function as a tunnel node, the data received by the configurable packet-based interfaces 54 from a downstream node is routed to the switching module 51 and then subsequently routed to another one of the configurable packet-based interfaces for transmission upstream without interpretation. For downstream transmissions, the data is interpreted to determine whether the destination of the data is local. If not, the data is routed downstream via one of the configurable packet-based interfaces 54 or 56.

When the multiple processor device 40 is configured as a bridge node, upstream packets that are received via a configurable packet-based interface 54 are modified via the interface 54, interface 56, the packet manager 52, the node controller 50, and/or processing units 42-44 to identify the current multiple processor device 40 as the source of the data. Having modified the source, the switching module 51 provides the modified data to one of the configurable packet-based interfaces for transmission upstream. For downstream transmissions, the multiple processor device 40 interprets the data to determine whether it contains the destination for the data. If so, the data is routed to the appropriate destination. If not, the multiple processor device 40 forwards the packet via one of the configurable packet-based interfaces 54 or 56 to a downstream device.

To determine the destination of the data, the node controller 50, the packet manager 52 and/or one of the processing units 42 or 44 interprets header information of the data to identify the destination (i.e., determines whether the target address is local to the device). In addition, a set of ordering rules of the received data is applied when processing the data, where processing includes forwarding the data, in packets, to the appropriate local destination or forwarding it onto another device. The ordering rules include the HT specification ordering rules and rules regarding non-posted commands being issued in order of reception. The rules further include that the interfaces are aware of whether they are configured to support a tunnel, bridge, or tunnel-bridge hybrid node. With such awareness, for every ordered pair of transactions, the receiver portion of the interface will not make a new transaction of an ordered pair visible to the switching module until the old transaction of an ordered pair has been sent to the switching module. The node controller, in addition to adhering to the HT specified ordering rules, treats all HT transactions as being part of the same input/output stream, regardless of which interface the transactions was received from. Accordingly, by applying the appropriate ordering rules, the routing to and from the appropriate destinations either locally or remotely is accurately achieved.

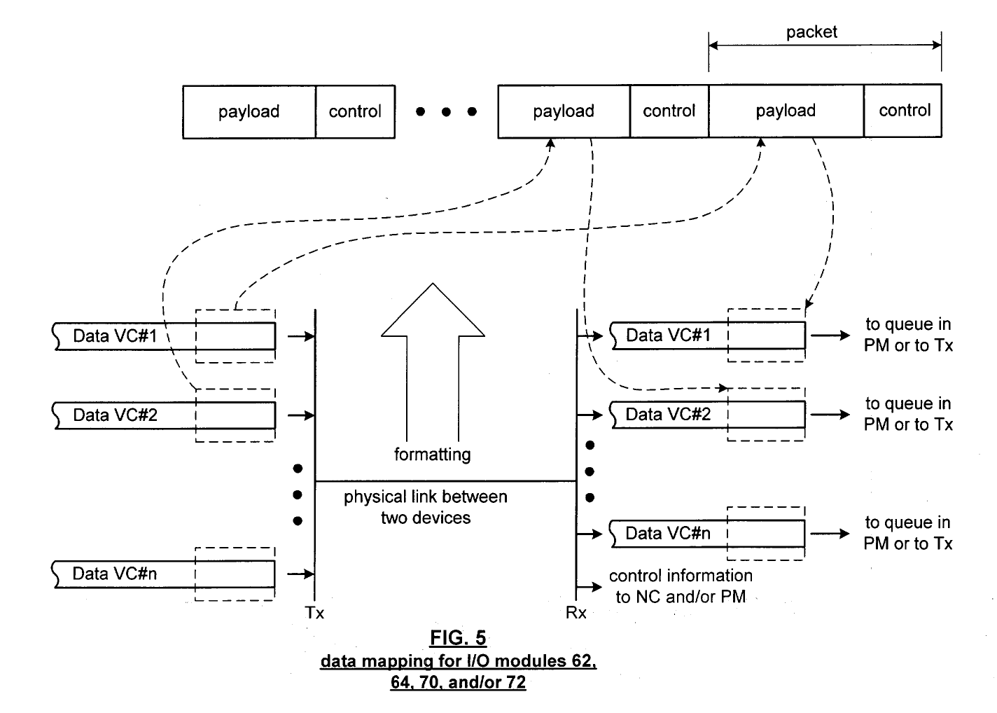

FIG. 5 is a graphical representation of the functionality performed by the node controller 50, the switching module 51, the packet manager 52 and/or the configurable packet-based interfaces 54 and 56. In this illustration, data is transmitted over a physical link between two devices in accordance with a particular high-speed communication protocol (e.g., HT, SPI-4, etc.). Accordingly, the physical link supports a protocol that includes a plurality of packets. Each packet includes a data payload and a control section. The control section may include header information regarding the payload, control data for processing the corresponding payload of a current packet, previous packet(s) or subsequent packet(s), and/or control data for system administration functions.

Within a multiple processor device, a plurality of virtual channels may be established. A virtual channel may correspond to a particular physical entity, such as processing units 42-44, cache memory 46 and/or memory controller 48, and/or to a logical entity such as a particular algorithm being executed by one or more of the processing modules 42-44, particular memory locations within cache memory 46 and/or particular memory locations within system memory accessible via the memory controller 48. In addition, one or more virtual channels may correspond to data packets received from downstream or upstream nodes that require forwarding. Accordingly, each multiple processor device supports a plurality of virtual channels. The data of the virtual channels, which is illustrated as data virtual channel number 1 (VC#1), virtual channel number 2 (VC#2) through virtual channel number N (VC#n) may have a generic format. The generic format may be 8 byte data words, 16 byte data words that correspond to a proprietary protocol, ATM cells, IP packets, TCP/IP packets, other packet switched protocols and/or circuit switched protocols.

As illustrated, a plurality of virtual channels is sharing the physical link between the two devices. The multiple processor device 40, via one or more of the processing units 42-44, node controller 50, the interfaces 54-56, and/or packet manager 52 manages the allocation of the physical link among the plurality of virtual channels. As shown, the payload of a particular packet may be loaded with one or more segments from one or more virtual channels. In this illustration, the 1^{st} packet includes a segment, or fragment, of virtual channel number 1. The data payload of the next packet receives a segment, or fragment, of virtual channel number 2. The allocation of the bandwidth of the physical link to the plurality of virtual channels may be done in a round-robin fashion, a weighted round-robin fashion or some other application of fairness. The data transmitted across the physical link may be in a serial format and at extremely high data rates (e.g., 3.125 gigabits-per-second or greater), in a parallel format, or a combination thereof (e.g., 4 lines of 3.125 Gbps serial data).

At the receiving device, the stream of data is received and then separated into the corresponding virtual channels via the configurable packet-based interface, the switching module 51, the node controller 50, the interfaces 54-56, and/or packet manager 52. The recaptured virtual channel data is either provided to an input queue for a local destination or provided to an output queue for forwarding via one of the configurable packet-based interfaces to another device. Accordingly, each of the devices in a processing system as illustrated in FIGS. 1-3 may utilize a high speed serial interface, a parallel interface, or a plurality of high speed serial interfaces, to transceive data from a plurality of virtual channels utilizing one or more communication protocols and be configured in one or more configurations while substantially overcoming the bandwidth limitations, latency limitations, limited concurrency (i.e., renaming of packets) and other limitations associated with the use of a high speed HyperTransport chain. Configuring the multiple processor devices for application in the multiple configurations of processing systems is described in greater in the following figures.

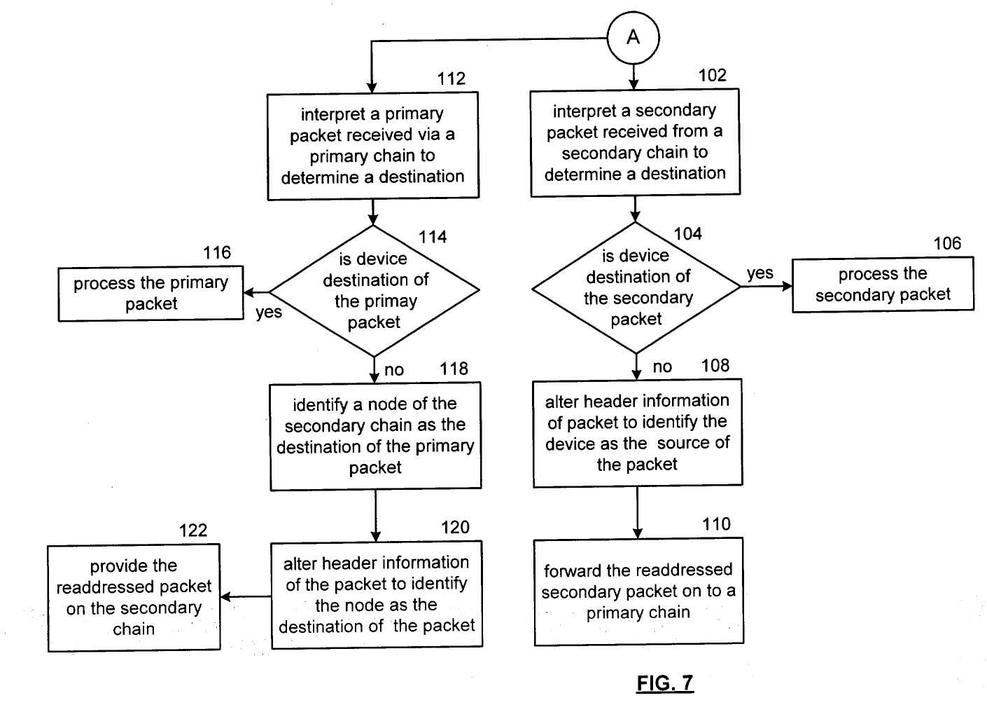

FIGS. 6 and 7 illustrate a logic diagram of a method that may be used by the multiple processor device 40 to function in one or more of the processing systems illustrated in FIGS. 1-3. The process begins at Step 80 where the device determines whether it is to be configured to function as a tunneling node, a bridge node or a tunnel-bridge hybrid node. The indication as to the particular mode of operation will either be provided by the host device, by a signaling indication from another entity, or based on a mode selection by the user of the device.

If the device is configured in the tunneling mode, the process proceeds to Step 82. At Step 82, for each packet received via each of the configurable packet-based interfaces, the device determines whether the data is an upstream packet or downstream packet. When the received packet is a downstream packet (i.e., received from a downstream device), the process proceeds to Step 92 where the device forwards the downstream packet received from a downstream node (i.e., further away from the host than the current device) to an upstream node (i.e., closer to the host than the current device) while maintaining the node identity of the node that originated the packet.

If the packet is an upstream packet the process proceeds to Step 84 where the device interprets the packet received from an upstream node to determine the packet's destination. The process then proceeds to Step 86 where the device determines whether one of its modules (e.g., processing units, cache memory, system memory, et cetera) is the destination of the packet. If so, the process proceeds to Step 88 where the packet is processed. The processing of the packet includes routing it to the appropriate destination within the device. If the device is not the destination of the packet, the process proceeds to Step 90 where the device forwards the packet to a downstream node.

The device can be configured in the tunnel-bridge hybrid mode at configuration time of the system by having the device, which is coupled in a tunnel manner, transmit a type 1 header (i.e., a bridge header in accordance with the HT specification) in addition to, or instead of, a type 0 header (i.e., a tunnel header in accordance with the HT specification). Also during the configuration process, the address range registers of the device are programmed with addresses for at least one of the links coupled to the device. Once in the tunnel-hybrid mode, the process proceeds to Step 94 where upstream and downstream packets are interpreted to determine a destination. Such an interpretation includes determining a destination address and/or source address of the packet, whether the packet corresponds to a request or a response, etc.

The process then proceeds to Step 96 where the device determines whether one of its modules is a destination of the packet, which may be based on the address of the destination. The determination may be done by matching the address of the packet with addresses in the address range registers to identify a link directly or indirectly coupled to the destination or whether the destination is local to the device. As such, regardless of whether the packet is an upstream or downstream packet, the device compares the address(es) of the packet with the addresses in the address range registers to determine the appropriate destination. If the destination is not local to the device, the process proceeds to Step 100 where the packet is forwarded on to a link based on the address matching without altering the source identity of the packet as would be done in accordance with a bridging function. For example, based on the destination address, the destination may be determined to be in the upstream direction from the device, thus the packet would be forwarded on the upstream link. Conversely, for example, the destination may be determined to be in the downstream direction and thus the packet would be forwarded on the downstream link. If a link cannot be identified by the address matching, the packet is forwarded on a default link, which may the upstream link, the downstream link, or another link.

If the device is a destination of the packet, the process proceeds to Step 98 where the packet is processed by routing it to the appropriate entity associated with the device. Such processing enables the multiple processor integrated circuit to interface with other devices utilizing one or more communication protocols and be configured in one or more configurations while overcoming bandwidth limitations, latency limitations, concurrency issues, and other limitations associated with high speed chains.

If the device is configured to function in a bridge mode, the process proceeds to Steps 112 and 102 as illustrated in FIG. 7. At Step 102, the device interprets a secondary packet received from a secondary chain to determine a destination. A secondary chain was illustrated in the system of FIG. 1 and in the system of FIG. 3.

The process then proceeds to Step 104 where the device determines whether one of its modules is a destination of the secondary packet. If so, the process proceeds to Step 106 where the device processes the secondary packet. If not, the device alters header information of the packet to identify itself as the source of the packet to produce a re-addressed, or modified, secondary packet. The process then proceeds to Step 110 where the device forwards the re-addressed, or modified, secondary packet on the primary chain.

At Step 112 the device interprets a primary packet received via the primary chain to determine the destination of the packet. The process then proceeds to Step 114 where the device determines whether one of its entities is a destination of the primary packet. If so, the process proceeds to Step 116 where the device processes the primary packet. If not, the process proceeds to Step 118 where the device identifies a node of the secondary chain as the destination of the packet. The process then proceeds to Step 120 where the device alters the header information of the packet to identify the node on the secondary chain as the destination of the packet to produce a re-addressed primary packet. The process then proceeds to Step 122 where the device provides the re-addressed primary packet on the secondary chain to the particular node.

The preceding discussion has presented a method and apparatus for interfacing multiple processor devices in a variety of ways utilizing a variety of communication protocols. In such various embodiments, the multiple processor devices when configured as illustrated, overcome bandwidth limitations, latency limitations and other limitations associated with the use of high speed HyperTransport chains in processing systems. As one of average skill in the art will appreciate, other embodiments may be derived from the teaching of the present invention, without deviating from the scope of the claims.

What is claimed is:

1. A multiple processor integrated circuit comprises:
a plurality of processing units;
cache memory;
memory controller operably coupled to system memory;
internal bus operably coupled to the plurality of processing units, the cache memory and the memory controller;
packet manager operably coupled to the internal bus;
node controller operably coupled to the internal bus;
first configurable packet-based interface;
second configurable packet-based interface; and
switching module operably coupled to the packet manager, the node controller, the first configurable packet-based interface, and the second configurable packet-based interface, wherein the multiple processor integrated circuit is configured, in accordance with first configuration information, to provide a tunnel, a bridge, or a tunnel-bridge hybrid for packets transceived via the first configurable packet-based interface, and wherein the multiple processor integrated circuit is configured, in accordance with second configuration information, to provide the tunnel, the bridge, or the tunnel-bridge hybrid for packets transceived via the second configurable packet-based interface.

2. The multiple processor integrated circuit of claim 1 further comprises:
header register section operable to store first header information of the first configuration information and to store second header information of the second configuration information, wherein the first header information indicates the tunnel, the bridge interface, or the tunnel-bridge hybrid processing of the packets transceived via the first configurable packet-based interface and wherein the second header information indicates the tunnel, the bridge, or the tunnel-bridge hybrid processing of the packets transceived via the second configurable packet-based interface.

3. The multiple processor integrated circuit of claim 1 further comprises:
the first configurable packet-based interface is configured to provide at least one of a HyperTransport (HT) input/output port and a System Packet Interface (SPI) input/output port; and
the second configurable packet-based interface is configured to provide at least one of the HyperTransport (HT) input/output port and the System Packet Interface (SPI) input/output port.

4. The multiple processor integrated circuit of claim 1 further comprises:
the first and the second configurable packet-based interfaces applying a set of ordering rules for the packets when the multiple processor integrated circuit is configured to provide the tunnel, the bridge, or the tunnel-bridge hybrid for packets transceived via the first or second configurable packet-based interfaces; and
the node controller applying the set of ordering rules for the packets as being received via a single input/output port regardless of whether the packets were received via the first or the second configurable packet-based interface, wherein the set of ordering rules includes non-post commands to a destination are issued in order.

5. The multiple processor integrated circuit of claim 1, wherein providing the tunnel processing of the packets further comprises:
forwarding a downstream packet received from a downstream node while maintaining node identity;
interpreting an upstream packet received from an upstream node to determine a destination of the upstream packet;
when the multiple processor integrated circuit is the destination of the upstream packet, processing the upstream packet; and
when the multiple processor integrated circuit is not the destination of the upstream packet, forwarding the upstream packet to the downstream node.

6. The multiple processor integrated circuit of claim 1, wherein providing the bridge processing of the packets further comprises:
interpreting a secondary packet received from a secondary chain to determine a destination of the secondary packet;
when the multiple processor integrated circuit is the destination of the secondary packet, processing the secondary packet;
when the multiple processor integrated circuit is not the destination of the secondary packet, altering header information of the secondary packet to identify the multiple processor integrated circuit as a source of the secondary packet to produce a readdressed secondary packet;
forwarding the readdressed secondary packet on to a primary chain;
interpreting a primary packet received via a primary chain to determine a destination of the primary packet;
when the multiple processor integrated circuit is the destination of the primary packet, processing the secondary packet;
when the multiple processor integrated circuit is not the destination of the primary packet, identifying a node of the secondary chain as the destination of the primary packet;
altering header information of the primary packet to identify the node as the destination of the primary packet to produce a readdressed primary packet; and
providing the readdressed primary packet on the secondary chain.

7. The multiple processor integrated circuit of claim 1, wherein providing the tunnel-bridge hybrid processing of the packets further comprises:
interpreting a packet of the packets received from a chain to determine a destination of the packet;
when the multiple processor integrated circuit is the destination of the packet, processing the packet; and
when the multiple processor integrated circuit is not the destination of the packet, forwarding the packet on to the chain.

8. The multiple processor integrated circuit of claim 7, wherein the forwarding the packet on to the chain further comprises:
determining an address of the destination of the packet;
comparing the address with an address range associated with a link supporting the chain;
when the address is within the address range, issuing the packet on the link; and
when the address is not within the address range, issuing the packet on a default link.

9. The multiple processing integrated circuit of claim 8, wherein the issuing the packet further comprises:
maintaining order of the packets regardless of identity of a destination node.

10. The multiple processor integrated circuit of claim 7 further comprises:
interpreting the packet to determine whether the packet is part of a request or a response;
when the packet is part of the request, determining the destination of the packet based on an address contained within the packet; and
when the packet is part of the response, determining the destination of the packet based on a unit identification code.

11. The multiple processor integrated circuit of claim 1 further comprises:
at least one of the first configurable packet-based interface, the second packet-based interface, the node controller, and the packet manager providing at least one of the tunnel processing of the packets, the bridge processing of the packets, and the tunnel-bridge hybrid processing of the packets.

12. A packet-based interface comprises:
input/output module operably coupled to amplify inbound data and to drive outbound packets;
media access control module operably coupled to the input/output module, wherein the media access control module formats outbound data to produce the outbound packets in accordance with a packet-based protocol and formats the amplified inbound data into inbound packets in accordance with the packet-based protocol; and
tunnel-bridge hybrid module operably coupled to:
interpret a packet of the inbound packets to determine a destination of the packet;
when the destination of the packet is a local module of the packet-based interface, providing the packet to the local module; and
when the destination of the packet is not local to the packet-based interface, forwarding the packet to the media access control module such that the packet is converted into an outbound packet.

13. The packet-based interface of claim 12, wherein the packet-based protocol further comprises at least one of HyperTransport (HT) and System Packet Interface (SPI).

14. The packet-based interface of claim 12 further comprises:
the tunnel-bridge hybrid module applying a set of ordering rules for the inbound packets, wherein the set of ordering rules includes non-post commands to a destination are issued in order.

15. The packet-based interface of claim 12, wherein the forwarding the packet further comprises:
determining an address of the destination of the packet;
comparing the address with an address range associated with a link;
when the address is within the address range, issuing the packet on the link; and
when the address is not within the address range, issuing the packet on a default link.

16. The packet-based interface of claim 15, wherein the issuing the packet further comprises:
maintaining order of the packets regardless of identity of a destination node.

17. The packet-based interface of claim 12 further comprises:
interpreting the packet to determine whether the packet is part of a request or a response;
when the packet is part of the request, determining the destination of the packet based on an address contained within the packet; and
when the packet is part of the response, determining the destination of the packet based on a unit identification code.

18. A processing system comprises:
a plurality of multiple processor devices, wherein each of the plurality of multiple processor devices includes a first packet-based interface and a second packet-based interface, wherein one of plurality of multiple processor devices functions as a host for the processing system and remaining ones of the plurality of multiple processor devices function as bridges to provide peer-to-peer communication among the remaining one of the plurality of multiple processor devices.

19. The processing system of claim 18, each of the plurality of multiple processor devices further comprises:
a plurality of processing units;
cache memory;
memory controller operably coupled to system memory;
internal bus operably coupled to the plurality of processing units, the cache memory and the memory controller;
packet manager operably coupled to the internal bus;
node controller operably coupled to the internal bus; and
switching module operably coupled to the packet manager, the node controller, the first packet-based interface, and the second packet-based interface.

20. The processing system of claim 19 further comprises:
the first packet-based interface is configured to provide at least one of a HyperTransport (HT) input/output port and a System Packet Interface (SPI) input/output port; and
the second configurable packet-based interface is configured to provide at least one of the HyperTransport (HT) input/output port and the System Packet Interface (SPI) input/output port.

21. The processing system of claim 19 further comprises:
the first and the second packet-based interfaces applying a set of ordering rules for the packets transceived via the first or second configurable packet-based interfaces; and
the node controller applying the set of ordering rules for the packets as being received via a single input/output port regardless of whether the packets were received via the first or the second packet-based interface, wherein the set of ordering rules includes non-post commands to a destination are issued in order.

22. The processing system of claim 19, wherein providing the bridge processing of the packets further comprises:
interpreting a secondary packet received from a secondary chain to determine a destination of the secondary packet;
when the multiple processor integrated circuit is the destination of the secondary packet, processing the secondary packet;
when the multiple processor device is not the destination of the secondary packet, altering header information of the secondary packet to identify the multiple processor device as a source of the secondary packet to produce a readdressed secondary packet;
forwarding the readdressed secondary packet on to a primary chain;
interpreting a primary packet received via a primary chain to determine a destination of the primary packet;
when the multiple processor device is the destination of the primary packet, processing the secondary packet;
when the multiple processor device is not the destination of the primary packet, identifying another one of the plurality of multiple processor devices on the secondary chain as the destination of the primary packet;
altering header information of the primary packet to identify the another one of the plurality of multiple processor devices as the destination of the primary packet to produce a readdressed primary packet; and
providing the readdressed primary packet on the secondary chain.

23. A processing system comprises:
a plurality of multiple processor devices, wherein each of the plurality of multiple processor devices includes a first packet-based interface and a second packet-based interface, wherein one of plurality of multiple processor devices functions as a host for the processing system and remaining ones of the plurality of multiple processor devices function as tunnel-bridge hybrids to provide peer-to-peer communication among the remaining one of the plurality of multiple processor devices.

24. The processing system of claim 23, wherein each of the multiple processor devices further comprises:
a plurality of processing units;
cache memory;
memory controller operably coupled to system memory;
internal bus operably coupled to the plurality of processing units, the cache memory and the memory controller;
packet manager operably coupled to the internal bus;
node controller operably coupled to the internal bus; and
switching module operably coupled to the packet manager, the node controller, the first packet-based interface, and the second packet-based interface.

25. The processing system of claim 24, wherein the node controller further comprises:
header register section operable to store first header information and second header information, wherein the first header information indicates tunnel-bridge hybrid processing of the packets transceived via the first packet-based interface and wherein the second header information indicates the tunnel-bridge hybrid processing of the packets transceived via the second packet-based interface.

26. The processing system of claim 25 further comprises:
the first packet-based interface is configured to provide at least one of a HyperTransport (HT) input/output port and a System Packet Interface (SPI) input/output port; and
the second packet-based interface is configured to provide at least one of the HyperTransport (HT) input/output port and the System Packet Interface (SPI) input/output port.

27. The processing system of claim 25 further comprises:
the first and the second packet-based interfaces applying a set of ordering rules for the packets; and
the node controller applying the set of ordering rules for the packets as being received via a single input/output port regardless of whether the packets were received via the first or the second packet-based interface, wherein the set of ordering rules includes non-post commands to a destination are issued in order.

28. The processing system of claim 25, wherein providing the tunnel-bridge hybrid processing of the packets further comprises:
interpreting a packet of the packets received from a chain to determine a destination of the packet;
when the multiple processor device is the destination of the packet, processing the packet; and
when the multiple processor device is not the destination of the packet, forwarding the packet on to the chain.

29. The processing system of claim 28, wherein the forwarding the packet on to the chain further comprises:
determining an address of the destination of the packet;
comparing the address with an address range associated with a link supporting the chain;
when the address is within the address range, issuing the packet on the link; and
when the address is not within the address range, issuing the packet on a default link.

30. The processing system of claim 29, wherein the issuing the packet further comprises:
maintaining order of the packets regardless of identity of a destination node.

31. The processing system of claim 28 further comprises:
interpreting the packet to determine whether the packet is part of a request or a response;
when the packet is part of the request, determining the destination of the packet based on an address contained within the packet; and
when the packet is part of the response, determining the destination of the packet based on a unit identification code.
